(19) United States
(12) Patent Application Publication
(10) Pub. No.: US 2006/0286503 A1
(43) Pub. Date: Dec. 21, 2006

(54) Dosing device including cartridge

(76) Inventor: Phillip Mark, Orlando, FL (US)

Correspondence Address: ERIC P. SCHELLIN, 6831 CLOISTERS DRIVE, \, Mc LEAN, VA, 22101, US

(21) Appl. No.: 11/155,968

(22) Filed: Jun. 20, 2005

(51) Int. Cl. A61C 5/04

(52) U.S. Cl. 433/90

(57) ABSTRACT

A dental cartridge for dispensing a dental material having a body portion made of a material transparent to at least a portion of the visible light spectrum and opaque to the actinic light of the dental material contained therein. The dental cartridge is supplied with a to-be driven piston which is constructed of two affixed parts in tandem, a forward portion and a rearward portion. The forward portion is more resilient than the rearward portion. The rearward portion is affixed to the forward portion by a peg system that fits into the forward portion.

### FIELD OF THE INVENTION

The present invention relates, generally, to dental dosing devices including cartridges for dispensing dental composite material with leveraged extruding syringe and more particularly to an improved cartridge and piston detailed to reciprocate in the cartridge.

### BACKGROUND OF THE INVENTION

Since the first introduction of a composite resin dental material filling syringe, such as the one disclosed in U.S. Pat. No. 3,581,399, there have been numerous improvements thereto. These improvements often related to the cartridge or tip containing the dental filling material used within a syringe, gun or extruding device.

Four examples of improved dental cartridges can be found in U.S. Pat. No. 4,391,590; U.S. Pat. No. 4,963,093; U.S. Pat. No. 5,100,320 and U.S. Pat. No. 5,122,057. These patents disclose a cartridge combined with a tip to be placed in a syringe for extruding the dental material contained within the cartridge or tip. They relate to an opaque cartridge having a first axis for the reservoir or body portion and a second linear axis for the nozzle discharge portion. The cartridges are intended to contain a light sensitive dental material that will cure or harden when exposed to a specific wavelength of light. Therefore, the cartridges are intended to be pre-loaded in a controlled environment for subsequent distribution to the dentist. The dentist then dispenses the dental material contained therein in a simple application. The said listed patents in the above are incorporated herein in their entirety.

U.S. Pat. No. 5,122,057 also discloses a cartridge or tip for dispensing dental material, comprising a body portion opaque to actinic light of the dental material contained therein and transparent to at least a portion of the visible light spectrum. This permits the dentist to see the material being placed within the body portion.

In an embodiment, the body portion is formed in the shape of a toroidal segment improving visibility and material flow. This embodiment is also combined with with a piston having an appendage to fit within the nozzle portion of the cartridge or tip. This permits complete extrusion of the costly dental material.

### SUMMARY OF THE INVENTION

Many dental restorative compositions become more viscous upon storage in the cartridges which are usually constructed of polymeric materials such as nylon-6. This is probably cause by absorption of polar components from the composition into the cartridge itself. Accordingly, some of the desired physical handling and dispensing properties of the compositions are compromised. Further, upon storage, the force to extrude a composition from a nylon-6 cartridge can become so high that the cartridge bursts when the composition is extruded at a useful rate, particularly a relatively viscous dental composition is extruded.

The invention overcomes this problem by providing a cartridge specially adapted to be mounted in a handheld ejector type gun, compromising:

a hollow cartridge body having an inner wall defining an elongate inner chamber open at one end of the body and adapted at the open end to be detachably mounted to the gun or such similar mechanically advantaged device, and having at the opposite end of the body an orifice to allow discharge of a dental composition from the inner chamber; and a two part piston inserted into the open end of the body wherein the body has an enhanced burst strength.

The body portion and/or tip portion is opaque to actinic light of the dental material contained therein and transparent to at least a portion of the visible light spectrum. This permits the dentist to see the material being placed within the body portion and/or the tip portion.

The piston has a front portion with a surface that is of shape that complements the closed discharge end of the cartridge. The piston is constructed of two substantially equal parts which are in tandem with the front portion constructed of a polymer that is more resilient than the rear portion. The front portion is molded with a centrally located recess in the bottom thereof. The rear portion is molded with a centrally located linearly extending “Christmas tree” spike adapted and constructed to mate into the recess of the said bottom of the front portion.

### BRIEF DESCRIPTION OF THE DRAWINGS

FIG. 1 is an exploded view of the invention showing the ejection piston apart from the cartridge;

FIG. 2 shows the piston secured in the cartridge which is transparent so the piston can be seen;

FIG. 3 is a perspective view of the piston in an exploded fashion whereby it can be seen that the piston comprises two parts;

FIG. 4 is a linear cross-sectional view of the piston of FIG. 3;

FIG. 5 is a cross-sectional view of the cartridge taken along line 5-5 of FIG. 1 and a cross-sectional view of the nozzle of the cartridge;

FIG. 6 is linear cross-sectional view of the cartridge.

### DETAILED DESCRIPTION OF THE INVENTION

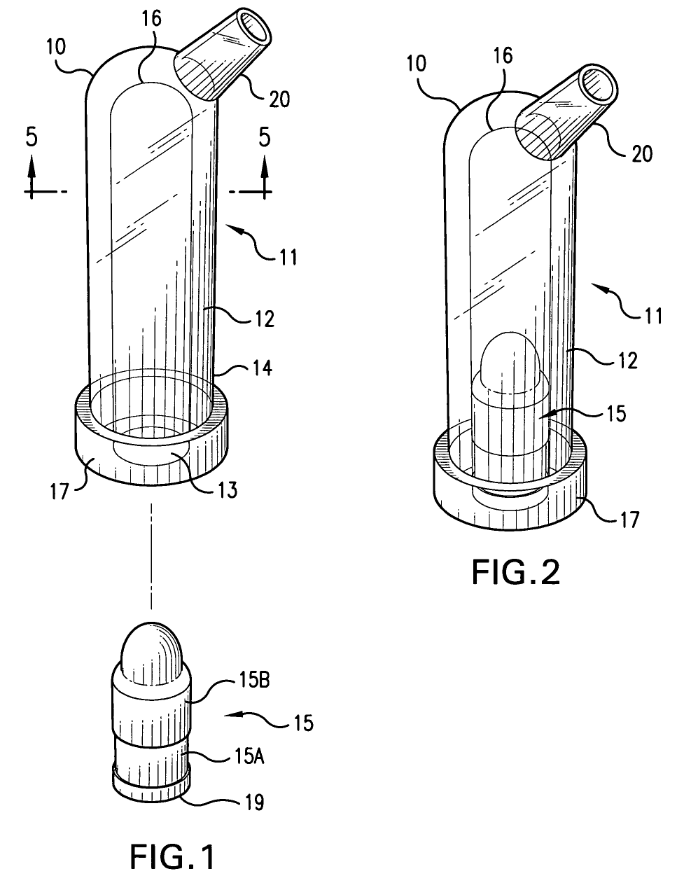

Attentions is called to FIG. 1, in particular, reference numeral 11 is shown to depict the present invention. The cartridge 12 is seen to have a structure resembling an inverted test tube. As an inverted test tube the mouth 13, thereof, is at the bottom portion 14 with a top portion10 terminating primarily in a dome 16. The cartridge is constructed of a transparent plastic that is of sufficient strength to make it essentially impervious to bursting when it is employed. The plastic employed is colored with a selective colored material which is transparent to normal light but is opaque to actinic light that is known to have a hardening or polymerizing affect on the material that has been loaded into the cartridge 12 for dispensing and destined for hardening at its place of use, such as a tooth of a patient requiring treatment.

The bottom portion 14 of the cartridge 12 terminates in a mouth 13 through which the cartridge 12 may be easily filled and into which the piston 15 may the be fitted, shown separated from the cartridge 12. A relatively large integral flange 17 circumscribes the bottom portion 14 and mouth 13 of the cartridge 12. The flange 17 is detailed to snap fit into a tool (not shown).

FIG. 2 depicts the piston 15 in position in the cartridge 12 substantially at the bottom portion 14. It can be seen, due to the relative transparency of the cartridge 12. When the cartridge is to be used for its dispensing function, the cartridge 12 without its piston 15 is loaded with the to be hardened material. The piston 15 is inserted into mouth 13 up to the terminus of the mouth 13 whereby the bottom 19 of the piston 15 is flush with the mouth 13. The cartridge 12 is mounted to a special tool (not shown) by means of the integral flange 17 which mates with an open ring on the tool in a snap manner. The said special tool possesses a rod plunger the forward leading end is in abutment against the bottom 19 of the piston 15 which is in the position shown by FIG. 2. When operated the rod plunger of the tool drives the piston 15 upwardly internally of the cartridge 12 in the direction of the dome 16 in the direction of nozzle 20. An applicable tool can be found in U.S. Pat. No. 5,122,057 at FIG. 1 of the drawings.

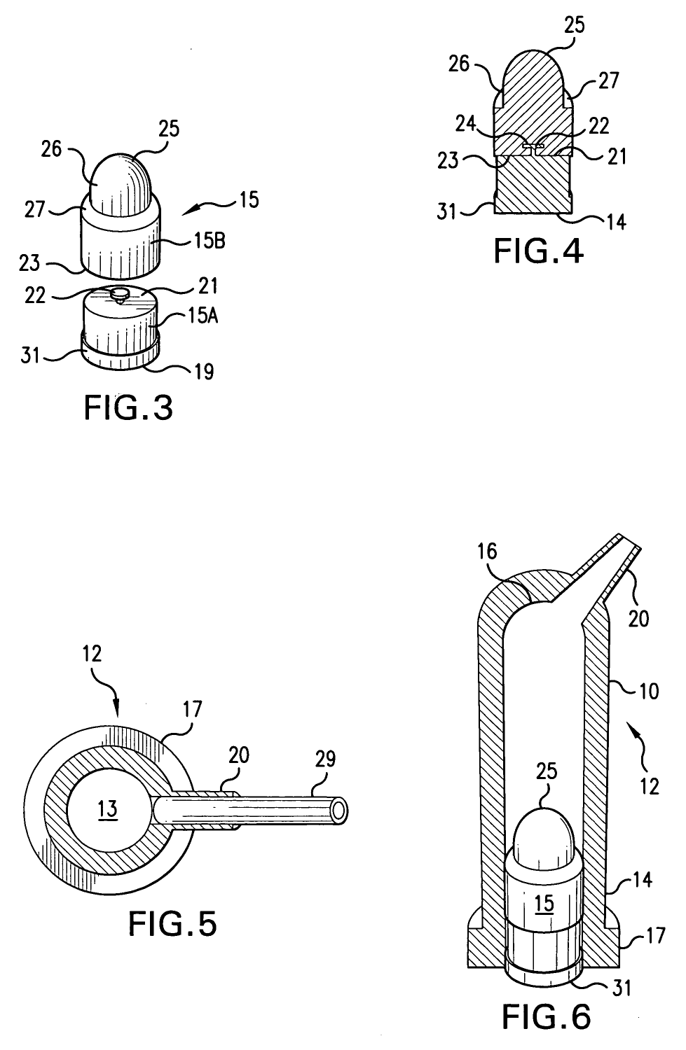

A primary feature of the present invention will now be discussed. The piston 15 has an unique construction. Attention is directed to FIGS. 3 and 4. Piston 15 comprises a lower cylindrical part 15A and an axially disposed upper cylindrical part 15B. The lower part 15A is constructed of a relatively hard polymeric material. The upper part 15B is constructed of a more resilient polymer than the lower part 15A. The two parts are nonadhesively held axially together. The upward facing surface 21 of the lower part 15A has integrally and centrally mounted thereon an upstanding mushroom-like appendage 22. The downwardly facing bottom surface 23 of the upper part 15B has a recess 24 detailed to complement the said mush-room like appendage 22. Assembly of part 15A and part 15B is facilitated by the fact that the lower part 15A is less resilient than the upper part 15B. As the lower part 15A is less resilient assembly of the two parts permits the appendage 22 to be forced in receiving mating recess 24, to result in assembly as demonstrated by the piston 15 of FIG. 4, which is shown in longitudinal cross section.

Another feature of the present invention resides in the unique structure of the upper part 15B of the piston 15. The upwardly facing portion is in the shape of a nose or a dome 25 substantially complementary to the downwardly facing dome 16 at the top of the cartridge 12. However, a lower portion 26 of the dome 25 has a smaller diameter than the remainder of the piston 15 so that there is an annular shoulder 27 that connects the said lower portion 26 with remainder of the piston 15B. As the piston 15 is moved under force in the direction of cartridge dome 16 and nozzle 20 the piston dome 25 is easily deformed against the underside of the dome of cartridge 12 to fill up the space while efficiently and completely extruding essentially all of the vestiges of the to be extruded material.

The part 15A of the piston has a flange 31 at the bottom most portion of a diameter so that it acts as a conventional piston ring as it is substantially of the same diameter as the inside diameter of the of the cartridge 12. On the other hand the part 15B is primarily of a diameter which is substantially the same as the inside diameter of the cartridge 12.

FIG. 5, is not only a rendition of cross-section, as indicated but also shows that a metal tube 29 may be frictionally or adhesively secured internally of the nozzle 30 of the cartridge 12.

In FIG. 6 it is possible to obtain additional insight as to positioning of the part of the cartridge 12 which is shown in cross-section while the piston 15 is not in cross section.

In the embodiment as shown the nozzle 20 is of a size and is configured to be sealed with a cap having a cup-like configuration. It is also contemplated that the nozzle be more elongated of ever diminishing diameter in the direction of its end so that goods be extruded therefrom may be carried more conveniently into a cavity of a tooth, for instance. In all instances in another embodiment the nozzle may be centrally located and extend axially from the cartridge.

Although the preferred embodiments have been illustrated and described, it will be obvious to those skilled in the art that various modifications may be made without departing from the spirit and scop of the invention.

What is claimed:

1. A cartridge specially adapted to be mounted in an ejector type gun, comprising: a hollow cylindrical cartridge body having an inner wall defining an elongate inner chamber open at one end of the body and adapted at the open end to be detachably and operatively mounted to said ejector gun and having at the opposite end of the body an orifice to allow discharge of a dental composition from the inner chamber; and a piston inserted into the open end of said body, said piston having a forward portion and a rearward portion, said forward portion and said rearward portion being affixed to one another, said forward portion being constructed of a resilient polymeric material, said rearward portion being constructed of a polymeric material that is relatively less resilient than the forward portion; said forward portion of said piston having an elongate leading cylindrical portion that has a smaller diameter than the piston and mates with the forward portion of the piston with a rounded shoulder, the elongate leading cylindrical portion terminates in a rounded nose, said piston adapted to slidably fit within said hollow cylindrical cartridge in a relative leak proof manner.

2. The hollow cylindrical cartridge body of claim 1 wherein the discharging dental composition may be a light activated dental composition and wherein the hollow cylindrical body being made of a material transparent to at least a portion of the visible light spectrum and opaque to the actinic light of the dental composition.

3. The hollow cylindrical cartridge body of claim 2 wherein the open end of the cartridge has a flange externally thereabout.

4. The hollow cylindrical cartridge body of claim 3 wherein said orifice terminates in a nozzle, said nozzle also being made of a material transparent to at least a portion of the visible light spectrum and opaque to the actinic light of the dental composition whereby the dentist can visually see the dental composition contained in the cartridge while preventing hardening of the dental material contained therein.

5. The hollow cylindrical cartridge body of claim 1 wherein the top of the rearward portion of the piston has a projection comprising of a substantially upstanding short rod terminating in a disc which is larger in diameter than said short rod; the downward facing bottom of the forward portion of the piston has a recess adapted and constructed to accept and retain said rearward portion of said piston.

6. The hollow cylindrical cartridge body of claim 5 wherein the discharging dental composition may be a light activated dental composition and wherein the hollow cylindrical body being made of a material transparent to at least a portion of the visible light spectrum and opaque to the actinic light of the dental composition.

7. The hollow cylindrical cartridge body of claim 5 wherein the open end of the cartridge has a flange thereabout.

8. The hollow cylindrical cartridge body of claim 5 where said orifice terminates in a nozzle, said nozzle also being made of a material transparent to at least a portion of the visible light spectrum and opaque to the actinic light of the dental composition whereby the dentist can visually see the dental composition contained in the cartridge while preventing hardening of the dental material contained therein.
